(19) United States
(12) Patent Application Publication
(10) Pub. No.: US 2019/0138999 A1
(43) Pub. Date: May 9, 2019

(54) SYSTEM AND METHOD OF AUTHENTICATING CANDIDATES FOR JOB POSITIONS

(71) Applicant: Komal Dangi, Edison, NJ (US)

(72) Inventor: Komal Dangi, Edison, NJ (US)

(21) Appl. No.: 15/806,608

(22) Filed: Nov. 8, 2017

(51) Int. Cl. G06Q 10/10; G06F 17/30; G10L 17/06; G10L 17/00

(52) U.S. Cl. CPC G06Q 10/1053; G06F 17/30867; G10L 17/005; G10L 17/06; G06F 17/30991

(57) ABSTRACT

A system and method of verifying a candidate for a job position. The system and method include a database and a web server having access to the database. Multiple clients may access the web server over a communications network, such as a telecommunications network, the Internet and the like. The clients use the web server to conduct interviews of the candidates, record and save the interviews to the database, and verify the identity of the candidates by comparing the recorded interviews.

### BACKGROUND OF THE INVENTION

The present invention relates to verification of candidates for job positions using voice and face biometrics.

Recruitment is a core function of human resource management. It is the first step of appointment. Recruitment refers to the overall process of attracting, selecting and appointing suitable candidates for jobs (either permanent or temporary) within an organization. Managers, human resource generalists and recruitment specialists may be tasked with carrying out recruitment, but in some cases public-sector employment agencies, commercial recruitment agencies, or specialist search consultancies are used to undertake parts of the process. Internet-based technologies to support all aspects of recruitment have become widespread.

The human resource industry is currently facing challenges regarding the authenticity of candidates for job positions. For example, candidates may falsify their resumes and/or have proxy interviews, in which individuals other than the candidate perform the interview.

As can be seen, there is a need for a system and method of authenticating candidates for job positions.

### SUMMARY OF THE INVENTION

In one aspect of the present invention, a system of verifying a candidate comprises a database hosting a web server, wherein the web server comprises: a search portal for a first client to search the database for candidate profiles based on entered search criteria; a list portal for consolidating selected candidate profiles from the search, initiating the first client to call each of the selected candidates for a first interview, recording the first interview and saving a recorded first interview to the database, initiating the first client to call each of the selected candidates for a second interview, recording the second interview and saving a recording of the second interview to the database; and a voice verification module to determine if a voice from the recording of the first interview matches a voice from the recording of the second interview.

In another aspect of the present invention, a computer implemented method of verifying a candidate comprises the steps of: searching, by a first client, a database for candidate profiles by entering search criteria on a web server wherein a plurality of results of the candidate profiles are displayed; selecting, by the first client, at least one of the candidate profiles within the plurality of results; calling, by the first client, a candidate of the candidate profile, wherein the web server automatically records a first interview and saves a first interview recording on a web server database; calling, by the first client, the candidate of the candidate profile, wherein the web server automatically records a second interview and saves a second interview recording on the web server database; comparing a first interview recording with the second interview recording using voice recognition software to determine if a voice from the first interview recording matches a voice from the second interview recording.

These and other features, aspects and advantages of the present invention will become better understood with reference to the following drawings, description and claims.

### BRIEF DESCRIPTION OF THE DRAWINGS

FIG. 1 is a schematic view of an embodiment of the present invention;

FIG. 2 is a flow chart of an exemplary method of the present invention;

FIG. 3 is a continuation of the flow chart of FIG. 2;

FIG. 4 is a block diagram of an embodiment of the present invention; and

FIG. 5 is a continuation of the block diagram of FIG. 4.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

The present invention includes a system and method of authenticating candidates using voice mapping, bio metrics and multi call functions. The voice verification for interviews includes mapped audio inputs from multiple interviews. The identification card verification may be verified by a third party. The experience verification includes a system that calculates expected actual experience by identifying the age of the candidate and comparing the age with the experience listed on the resume. The present invention may further include a predictive dialer for recruiters to cut down their time on dialing resources to find their availability.

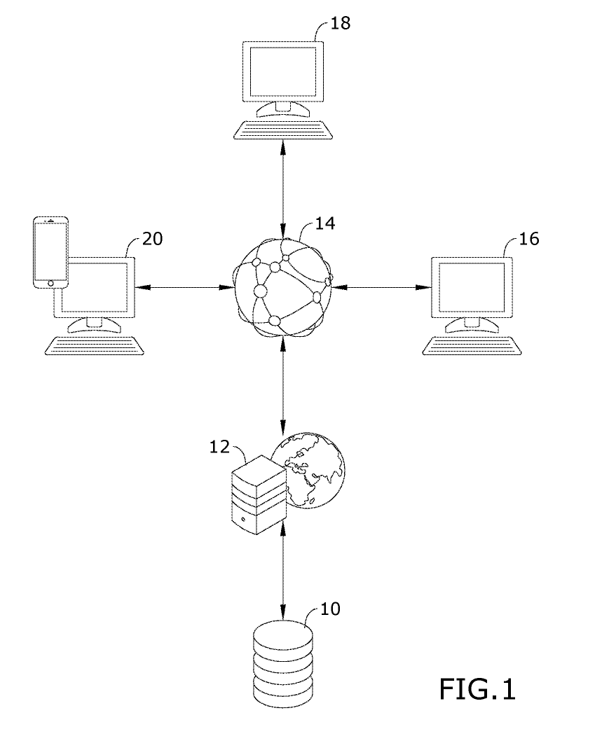

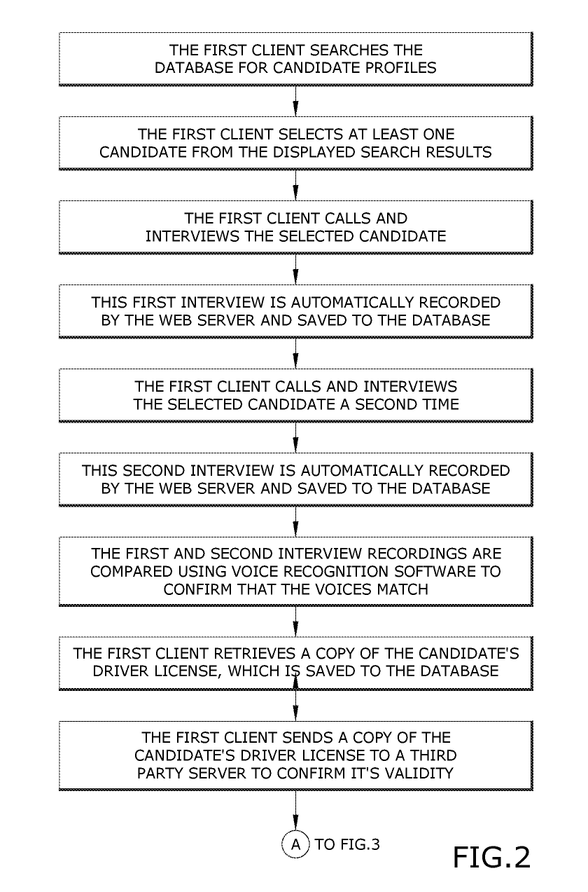

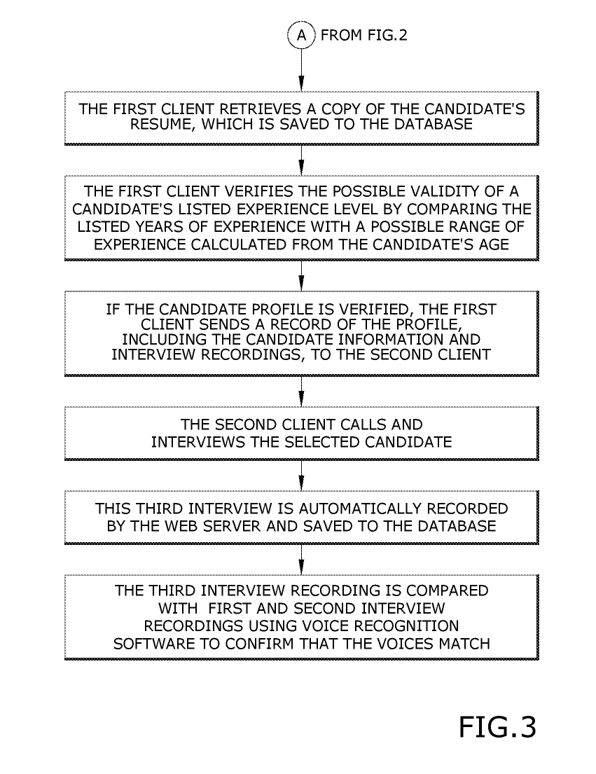

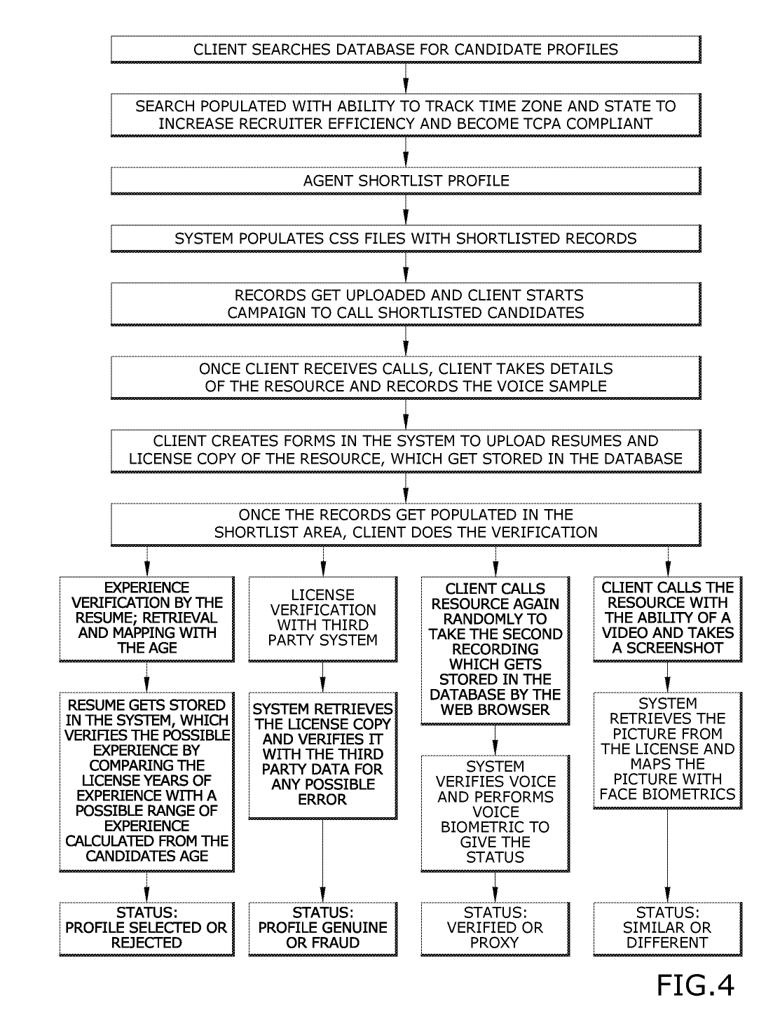

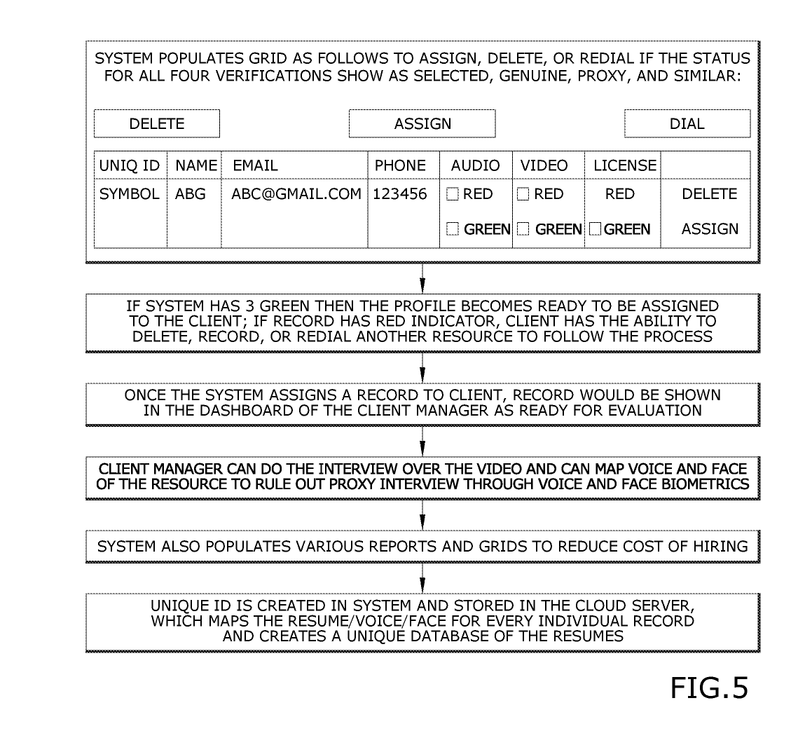

Referring to FIGS. 1 through 5, the present invention includes a system and method of verifying a candidate for a job position. The system and method include a database 10 and a web server 12 having access to the database 10. Multiple clients 16, 18 may access the web server 12 over a communications network 14, such as a telecommunications network, the Internet and the like. The clients 16, 18 use the web server 12 to conduct interviews of the candidates 20, record and save the interviews to the database 10, and verify the identity of the candidates by comparing the recorded interviews.

Using the present invention, clients 16, 18 initially sign up to access the web server 12 by creating a username and password. The client 16, 18 may do so using a computer accessing the web server 12 over the Internet. The computer includes software, such as an Internet browser, that enables the computer to display information received from the web server 12 on a display device of the computer. The computer may include input devices such as a mouse and a keyboard that allows the client 16, 18 to input data. In certain embodiments, the computer may be a smart device with a touch screen interface, such as a smart phone or a tablet. The smart device may include a software application (app) loaded on a memory. The app allows the clients 16, 18 to sign onto the web server 12 and access the web server over the Internet.

The clients 16, 18 of the present invention may include at least a first client 16 and a second client 18. The first client 16 may be a recruitment company. The recruitment company may include a recruiter and a recruiter manager. The second client 18 may be a company in search for the employee, i.e. an employer.

The first client 16 signs into the web server 12 and begins to search for potential candidates via a search portal of the web server 12. In certain embodiments, the database 10 may store a plurality of candidates' names linked to additional information, such as their location and specialty skills. The web server 12 provides the search portal in which the first client 16 may perform a search of the plurality of candidates within the database 10. In alternative embodiments, the search portal may access other job searching third party websites' databases, such as, but not limited to DICE™, MONSTER™, CAREERBUILDING ™, TECHFETCH™ and the like via the Internet. The first client 10 may thereby search for a candidate using the search portal and the web server 12 pulls candidate profiles from the job searching websites and presents the candidate profiles to the user.

Once the search has been performed, the web server 12 provides a list of candidate profiles that match the search entered by the first client 16. For example, the list may be in the form of cascading style sheet (CSS) files. Each of the candidate profiles may include the candidates name and a brief overview of the candidate. The web server 12 may also display the location of user as well as the time zone to increase recruiter efficiency. The first client 16 may select the candidates name and an expanded candidate profile may generate. The expanded candidate profile may include additional details of the candidate. The additional details may include, but not are limited to, specialty skills, years of experience, location, willingness to relocate, desired job position, hourly rate, salary request and any other data that may be pulled from the job searching websites or that is already stored on the database 10. The first client 16 may review the expanded candidate profile. If the first client 16 is interested in interviewing the candidate, the first client 16 may save the profile to a manage list portal.

The manage list portal provides a list of all of the candidate profiles in which the first client 16 has saved. For example, the list may be in the form of cascading style sheet (CSS) files. When the first client 16 has saved the candidate, the web server 12 prompts the first client 16 to call the candidate 20 and retrieve additional information. In such embodiments, the recruiter of the recruiting company may call the candidate 20 to retrieve additional information. The first client 16 calls the candidate 20 and retrieves the additional information, such as, but not limited to, the candidate's date of birth, address, email address, a resume to upload, and pictures of the front and back of the candidate's identification card (state driver's license/passport). The first client 16 may enter the information to the web server 12 via the manage list portal. The additional information is saved to the database 10. The first interview may be automatically recorded and saved to the database 10.

Once the additional information has been added, the lists of the candidate profiles may be moved to a candidate list portal. The candidate list portal allows the first client 16 to verify the candidates voice with a voice verification module, verify the candidates age with an age verification module and verify the candidate's identification card with an identification card verification module.

The manager of the recruiter may use the candidate list portal to call the candidate 20 for an interview. The manager may randomly call the candidate to ask technical questions. A second phone call is automatically recorded and saved to the database 10. The manager may select a verify voice button which prompts the web server 12 to use voice recognition software of the voice verification module to compare the first recorded phone call and the second recorded phone call. If the voice verification module determines that the first recorded phone call matches the voice of the second recorded phone call, the web server 12 indicates the same candidate 20 conducted both interviews. If the voice verification module determines that the first recorded phone call does not match the voice of the second recorded phone call, the web server 12 indicates the candidate profile is fraudulent.

The first client 16 may further verify the user's identification card and the user's experience. The manager may further select a verify identification card button which prompts the web server 12 to send the picture of the candidates identification card to a third party verification server. The third party verification server may communicate with the web server 12 over the communications network 14 and verify that the identification card is not fraudulent. Once the identification card has been verified, the manager may further select a verify experience button, which prompts the web server 12 to compare the age of the candidate 20 with the user's listed years of experience. The age of the candidate 20 may be pulled by the copy of the identification card. If the listed years of experience is within a possible range of experience based on the candidates age, the web server lists the candidate profile as verified. If the listed years of experience is outside of a possible range of experience based on the candidates age, the web server lists the candidate profile as fraudulent.

If the candidate's identification card, voice and amount of experience has been verified by the web server 12, the first client 16 may then send an email and transfer the record to a second client 18 via a transfer portal. The first client 16 may do so by selecting a transfer button which prompts the first client 16 to enter the second client's 18 and identifier, such as an email address, phone number, username and the like. The first client 16 enters the second client's 18 identifier and selects a send button. The web server 12 then transfers the records of the verified candidate profile from the first client 16 to the second client 18. The second client 18 may then interview the candidate 20 and use the voice verification module. The web server 12 allows the second client 18 to dial the phone number of the candidate and automatically records and stores a third recorded phone call. The second client 18 may select a verify voice button which prompts the web server 12 to use the voice recognition software of the voice verification module to compare the third recorded phone call with the first and second recorded phone call. If the voice verification module determines that the third recorded phone call matches the voice of the first and second recorded phone call, the web server 12 may indicate the voice of the candidate 20 has been verified to the second client 18. If the voice verification module determines that the third recorded phone call does not match the voice of the first and second recorded phone call, the web server 12 may indicate the voice of the candidate 20 is fraudulent to the second client 18.

In certain embodiments, the present invention may include a facial recognition module to further authenticate candidates 20. For example, interviews may be conducted via video chat. In such embodiments, a first interview is conducted in which a snapshot of the client is taken or a recorded video chat is saved to the database 10. The clients 16, 18 may select a verify facial button which prompts the web server 12 to use facial recognition software, such as face biometrics, of the facial verification module to compare the recorded video chat or snapshot with the picture on the identification card. If the facial verification module determines that the face of the recorded video or snapshot matches the face of the picture on the identification card, the web server 12 indicates the same candidate 20 conducted both interviews. If the facial verification module determines that the recorded video chat or the snapshot does not match the picture on the identification card, the web server 12 indicates the candidate is fraudulent.

The present invention may further include an automatic dialer module. In such embodiments, when the first client 16 adds the candidate profiles from the search results to the manage list portal each of the candidates' names and phone numbers may be uploaded to a spreadsheet. The automatic dialer module then automatically calls each of the candidates 20 in the order on the spreadsheet. If the candidate 20 answers the phone, the automatic dialer module automatically transfers the candidate to the recruiter (first client 16). If the phone call goes to a voice mail, the automatic dialer module may leave a prerecorded voicemail for the candidate to call a phone number back.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A system of verifying a candidate comprising a database hosting a web server, wherein the web server comprises:
a search portal for a first client to search the database for candidate profiles based on entered search criteria;
a list portal for consolidating selected candidate profiles from the search, initiating the first client to call each of the selected candidates for a first interview, recording the first interview and saving a recorded first interview to the database, initiating the first client to call each of the selected candidates for a second interview, recording the second interview and saving a recording of the second interview to the database; and
a voice verification module to determine if a voice from the recording of the first interview matches a voice from the recording of the second interview.

2. The system of claim 1, wherein the list portal further prompts the first client to retrieve a copy of the selected candidate's identification card and upload the copy of the identification card to the database.

3. The system of claim 2, wherein the web server further comprises an identification card verification module to send the copy of the identification card to a third-party server over a communications network and confirm the identification card is not fraudulent.

4. The system of claim 1, wherein the list portal further prompts the first client to retrieve a copy of the candidates resume and upload the copy of the resume to the database.

5. The system of claim 4, wherein the web server further comprises a verify experience module which compares a listed years of experience from the resume with a possible range of experience calculated based on an age of the candidate, to determine if the listed years of experience is possibly true.

6. The system of claim 1, wherein the web server further comprises a transfer portal for sending a record of a verified candidate from the first client to a second client, wherein the record comprises the candidate information, the recorded first interview and the recorded second interview, wherein the record is uploaded to the list portal of the second client.

7. The system of claim 6, wherein the list portal of the second client initiates the second client to call the verified candidate for a third interview, wherein the web server records the third interview and saves a third interview recording to the database, wherein the voice verification module determines if a voice from the third interview recording matches the voice from the first and second interview recordings.

8. A computer implemented method of verifying a candidate comprising the steps of:
searching, by a first client, a database for candidate profiles by entering search criteria on a web server wherein a plurality of results of the candidate profiles are displayed;
selecting, by the first client, at least one of the candidate profiles within the plurality of results;
calling, by the first client, a candidate of the candidate profile, wherein the web server automatically records a first interview and saves a first interview recording on a web server database;
calling, by the first client, the candidate of the candidate profile, wherein the web server automatically records a second interview and saves a second interview recording on the web server database;
comparing a first interview recording with the second interview recording using voice recognition software to determine if a voice from the first interview recording matches a voice from the second interview recording.

9. The method of claim 8, further comprising the step of retrieving, by the first client, a copy of an identification card of the candidate of the candidate profile, wherein the copy of the identification card is saved to the web server database.

10. The method of claim 9, further comprising the step of sending, by the first client, the copy of the identification card to a third-party server over a communications network to confirm the identification card is not fraudulent.

11. The method of claim 8, further comprising the step of retrieving, by the first client, a copy of a resume of the candidate of the candidate profile, wherein the copy of the resume is saved on the web server database.

12. The method of claim 11, further comprising the step of verifying, by the first client, an experience level of the candidate by comparing a listed years of experience from the resume with a possible range of experience calculated based on an age of the candidate to determine if the listed years of experience is possibly true.

13. The method of claim 8, further comprising the step of sending, by the first client, a record of the candidate profile to a second client if the candidate profile is verified, wherein the record comprises the candidate information, the first interview recording and the second interview recording.

14. The method of claim 13, further comprising the steps of:
calling, by the second client, the candidate of the candidate profile, wherein the web server automatically records a third interview and saves a third interview recording to the web server database;
comparing the third interview recording with the first and second interview recording using voice recognition software to determine if a voice from the first and second interview recording matches a voice from the third interview recording. Page 13 of 14
